(19) United States
(12) Patent Application Publication
(10) Pub. No.: US 2025/0335488 A1
(43) Pub. Date: Oct. 30, 2025

(54) PREVENTION OF VIOLATION OF SECURITY POLICIES AND COMPLIANCE DURING ENROLLMENT ON WEB APPLICATIONS AND SYSTEMS

(71) Applicant: Kyndryl, Inc., New York, NY (US)

(72) Inventors: Cesar Augusto Rodriguez Bravo, Alajuela (CR); Steven Kurlowecz, Carlisle, MA (US); Ilyas Iyoob, Pflugerville, TX (US); Sachio Iwamoto, Richmond Hill (CA)

(21) Appl. No.: 18/646,427

(22) Filed: Apr. 25, 2024

(51) Int. Cl. G06F 16/35; G06F 40/205; G06F 40/284; G06F 40/30; H04L 9/40

(52) U.S. Cl. CPC G06F 16/35; G06F 40/205; G06F 40/284; G06F 40/30; H04L 63/20

(57) ABSTRACT

The present disclosure relates generally to computer security and, more particularly, to a system and method to detect violations of security policies and compliance during enrollment of web applications and systems. A computer-implemented method includes: ingesting, by a computing device, internal security policies of an organization and external terms and conditions of a web-based activity; identifying, by the computing device, topics of the internal security policies of the organization and the external terms and conditions of the web-based activity; parsing, by the computing device, dependencies within the internal security policies of the organization and the external terms and conditions of the web-based activity; and creating, by the computing device, clusters of the internal security policy and clusters of the external terms and conditions of the web-based activity based on the identifying and parsing.

### BACKGROUND

Aspects of the present invention relate generally to computer security and, more particularly, to a system and method to detect violations of security policies and compliance during enrolment of web applications and systems.

Internal terms of use or terms and conditions such as internal cookie policies are important to maintain the integrity of a computing system or network of computing systems of an organization. There are often buried in such agreements hidden permissions that may grant access to a camera, make phone calls, and/or gather location data that may violate an organization's stated policies.

### SUMMARY

In a first aspect of the invention, there is a computer-implemented method including: ingesting, by a computing device, internal security policies of an organization and external terms and conditions of a web-based activity; identifying, by the computing device, topics of the internal security policies of the organization and the external terms and conditions of the web-based activity; parsing, by the computing device, dependencies within the internal security policies of the organization and the external terms and conditions of the web-based activity; and creating, by the computing device, clusters of the internal security policies and clusters of the external terms and conditions of the web-based activity based on the identifying and parsing.

In another aspect of the invention, there is a computer program product including one or more computer readable storage media having program instructions collectively stored on the one or more computer readable storage media. The program instructions are executable to: ingest internal security policies of an organization and external terms and conditions of a web-based activity; cluster terms within the internal security policies based on similarities and which identify rules; cluster terms within the external terms and conditions of the web-based activity based on similarities and which identify rules; matching and comparing the clusters to determine that external terms and conditions of the web-based activity violate rules of the internal security policies; and provide an action based on whether the clusters match and have an alignment of the rules within the matched clusters.

In another aspect of the invention, there is system including a processor, a computer readable memory, one or more computer readable storage media, and program instructions collectively stored on the one or more computer readable storage media. The program instructions are executable to: ingest internal security policies of an organization and external terms and conditions of a web-based activity; cluster terms within the internal security policies based on similarities and which identify rules; cluster terms within the external terms and conditions of the web-based activity based on similarities and which identify rules; matching and comparing the clusters to determine that external terms and conditions of the web-based activity violate rules of the internal security policies; and provide an action based on whether the clusters match and have an alignment of the rules within the matched clusters.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a flowchart of an exemplary clustering method in accordance with aspects of the invention.

FIG. 5 shows a flowchart of an exemplary analysis method in accordance with aspects of the invention.

FIG. 6 shows an illustrative example of a tokenization process in accordance with aspects of the present invention.

FIG. 7 shows an illustrative example of an entity extraction process in accordance with aspects of the present invention.

FIG. 8 shows an illustrative example of a topic modeling process in accordance with aspects of the present invention.

FIG. 9 shows an illustrative example of a dependency parsing process in accordance with aspects of the present invention.

FIG. 10 shows an illustrative example of a clustering process in accordance with aspects of the present invention.

FIGS. 11-13 show exemplary actions taken in accordance with aspects of the present invention.

### DETAILED DESCRIPTION

Aspects of the present invention relate generally to computer security and, more particularly, to a system and method to detect violations of security policies and compliance during enrollment of web applications and/or other systems. More specifically, aspects of the invention are directed to a system and method to analyze terms of use or terms and conditions such as cookie agreements against a stated policy (e.g., cookie acceptance policy amongst other terms of use or terms and conditions) of an organization in order to prevent acceptance of cookies that may not comply with the stated policy. In this way, the system and method will prevent violations of the security policies and ensure compliance during enrollment on web applications, etc., by analyzing the terms and conditions (cookie clause amongst other terms of use or terms and conditions) and comparing it with the organization's acceptance policy. These policies may, for example, deny access to a camera, deny access to make phone calls, and/or deny access to gather location data, amongst many other prohibited or allowed activities. Advantageously, the present invention is aimed to be implemented as part of a cybersecurity solution suite in which the present method and system provides an extension that will help organizations to reduce the risk associated with the exposure of sensitive data and the non-compliance of internal/external security policies and regulations. Also, the system and/or method can be implemented as a computer program product.

For example, the system and method will ingest the terms and conditions of an internal policy (e.g., cookie acceptance policy) using natural language processing, amongst other processes, and compare the internal policy to an ingested policy of a website, web application and/or other system in which the user seeks access. The system and method will determine whether there are any prohibited actions that may occur by accepting the policy of the website, web application and/or other system in which the user seeks access. If a prohibited activity is found, the system and method will alert the user and prevent acceptance of such policy from being implemented from the website, web application and/or other system in which the user seeks access. In this way, aspects of the present invention ensure that the user will not violate an organization's internal security policies, thereby protecting the organization's computer systems and/or network.

Accordingly, the system, method and computer program product provide a technical feature (e.g., technical solution) to a technical problem and a practical application of analyzing acceptance policies and policy of a website, web application and/or other system in which the user seeks access, and prohibiting acceptance and, hence, access to a website, web application and/or other system that may present a violation of the internal acceptance policy of terms of use or terms and conditions, for example. In embodiments, the system, method and computer program product may provide system alerts to the user trying to access the website, web application and/or other system. The alert may also be provided to a member of the Information Technology (IT) support team or other administrator. The system, method and computer program may also block access to the website, web application and/or other system should access violate an internal stated security policy. The system, method and computer program can also place the website, web application and/or other system on a blacklist so that future users cannot gain access to such website, web application and/or other system.

To the extent implementations of the invention collect, store, or employ personal information provided by, or obtained from, individuals (for example, passwords and usernames) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

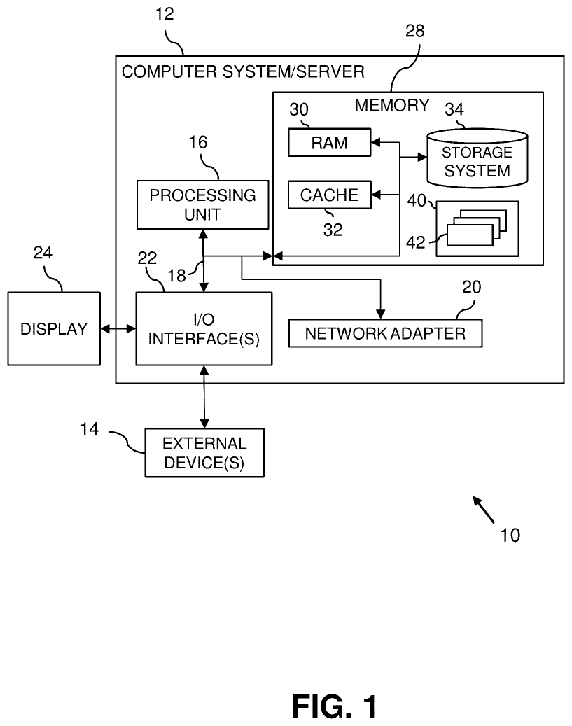

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

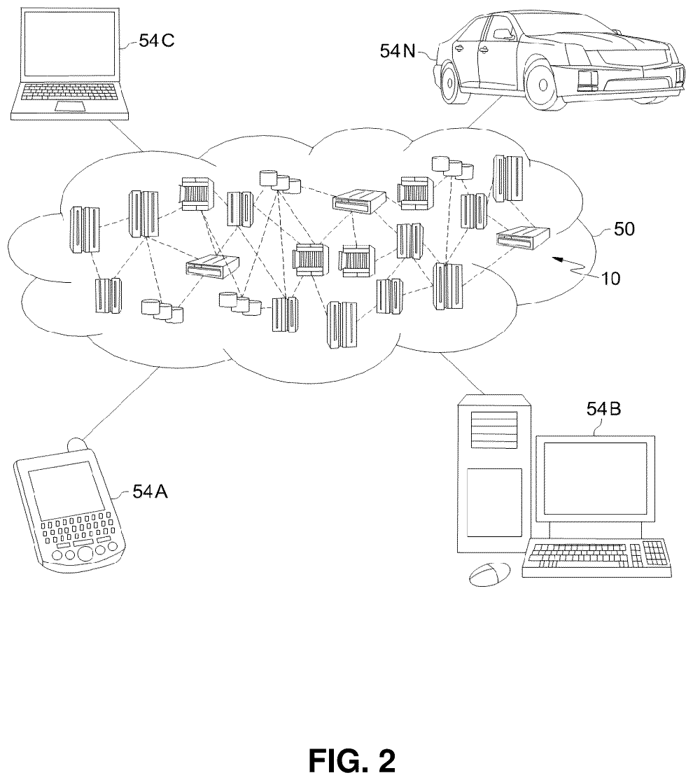

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

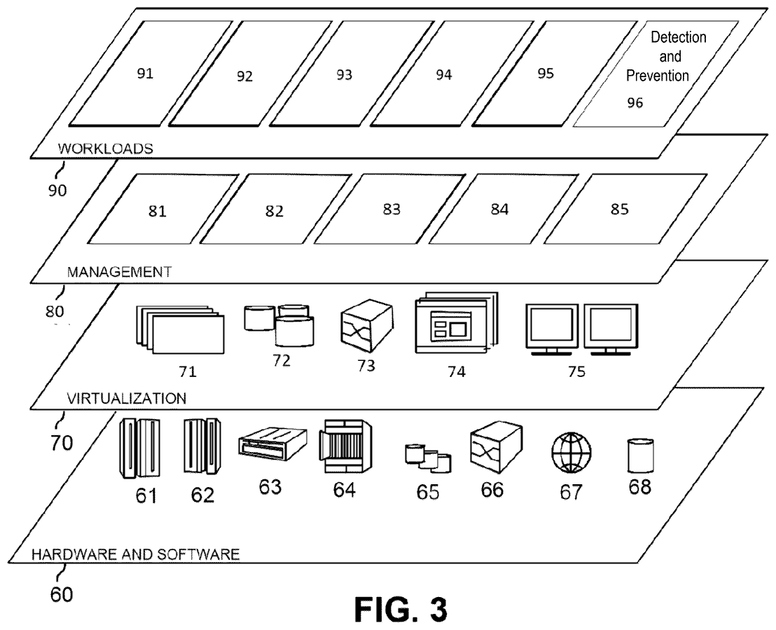

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and detection and prevention 96.

It should be understood that the program modules and, particularly, program modules 42 of FIG. 3 may be implemented in the exemplary environment of FIGS. 1 and 2. In embodiments, the program modules 42 may be separate modules or may be integrated into a single module. Additionally, or alternatively, a single module may be implemented as multiple modules. Moreover, the environment may include devices and/or networks; fewer devices and/or networks; different devices and/or networks; or differently arranged devices and/or networks than illustrated in FIGS. 1 and 2.

For example, implementations of the invention may include a computer system/server 12 of FIG. 1 in which one or more of the program modules 42 are configured to perform (or cause the computer system/server 12 to perform) one of more functions of the detection and prevention 96 of FIG. 3. For example, the one or more of the program modules 42 are configured to ingest internal security policies to understand the contents of the internal security policies, and create clusters (similarities as described further herein) of the internal policies. Similarly, the program modules 42 will ingest external terms and conditions of web applications, etc., to understand the contents of the external terms and conditions, and create clusters of such external terms and conditions. The program modules 42 will utilize natural language processing (NLP) engines to determine the specifics of each rule (cluster) of the internal policies and the terms and conditions. The program modules 42 contrast the specifics of each cluster to determine potential non-compliance with the internal policies by the external terms and conditions. For example, the program modules 42 will determine the intent of a cluster in order to match internal policies with the external terms and conditions. More specifically, if there are matches found between the clusters and there is no alignment of terms of any of the matched clusters (e.g., non-compliance with the internal policies by the external terms and conditions), the program modules 42 execute a plurality of actions based on the type of policy violated. These actions may be, for example, to block the webpage, provide notifications to the security team or blacklist the webpage, etc.

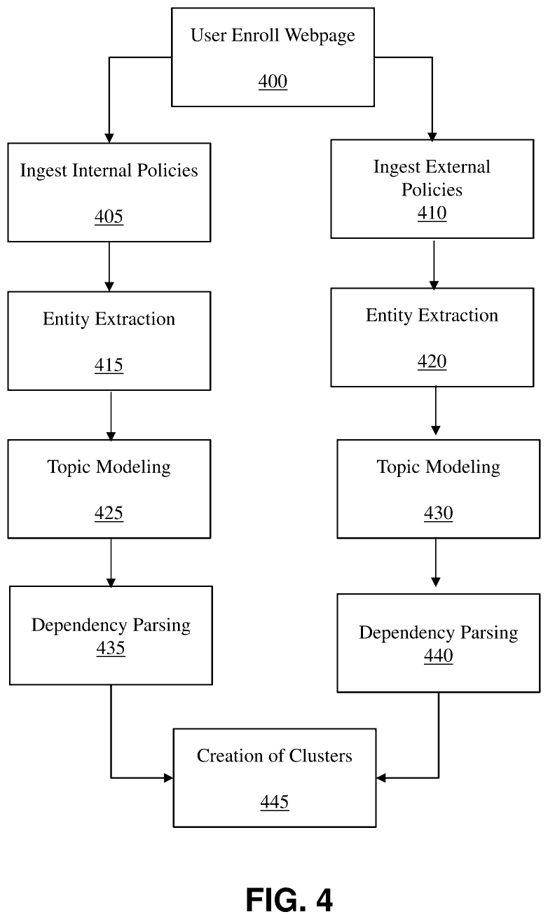

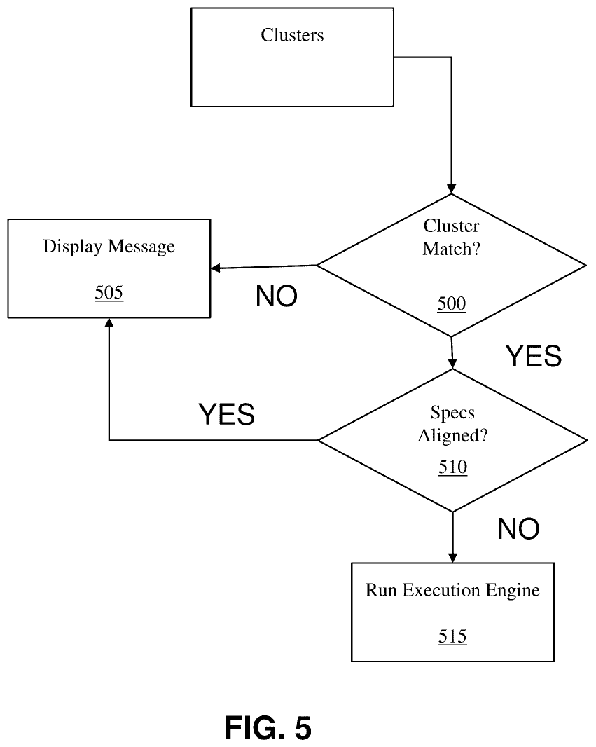

FIGS. 4 and 5 show respective flowcharts of exemplary methods in accordance with aspects of the present invention. Steps of the method may be carried out in the environments of FIGS. 1, 2 and/or 3. At step 400, the system

In FIG. 4, at step 400, the user attempts to enroll in a webpage, web application or a system. This includes acceptance of the terms and policies of the webpage, web application or a system. The terms and policies will include, amongst other things, acceptance of cookies (referred to as an “external cookie clauses”) in accordance with the policies of the webpage, web application or a system. It should be recognized that the terms and policies may be any terms of use or terms and conditions.

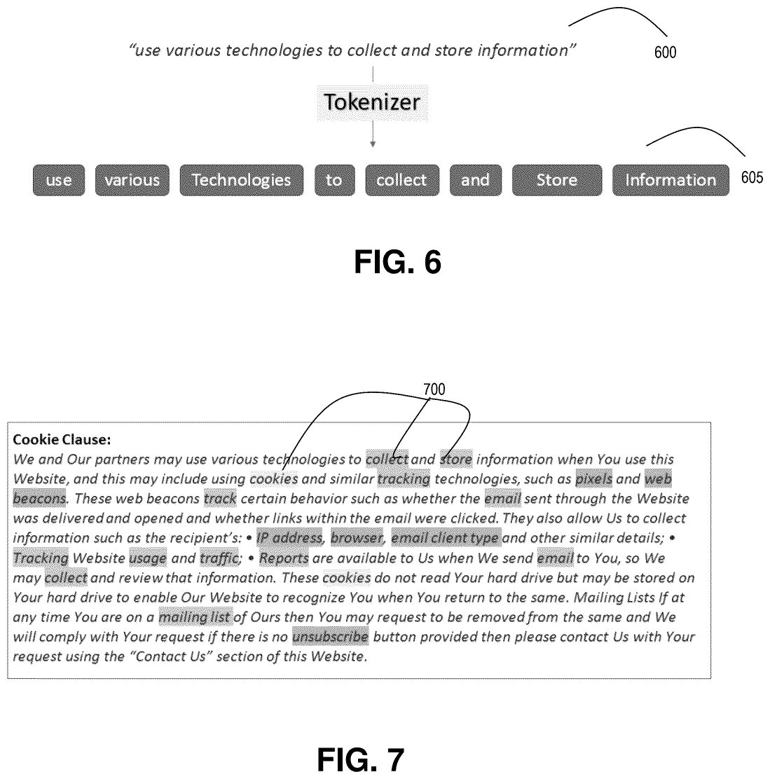

At step 405, the system will ingest the internal policies of the organization. These policies may include, e.g., cookie acceptance policies amongst other terms of use or terms and conditions. Similarly, at step 410, the system will ingest terms and policies of the webpage, web application or a system, e.g., external cookie clauses amongst other terms of use or terms and conditions. In embodiments, the ingestion of the cookie acceptance policies and the external cookie clauses, amongst other terms of use or terms and conditions, includes an analysis of the text using a natural language processing (NLP) algorithm to break down the text into individual words or tokens. For example, the NLP may be a tokenization algorithm as shown graphically in FIG. 6.

As should be understood by those of skill in the art, tokenization is a text-processing step for large language models. The tokenization splits text into smaller units called tokens that can be fed into a language model. Tokens can be words, characters, or even sub-words depending on what splitting algorithm is being employed. By way of example, the tokenization algorithm may be a word based tokenization, which is designed to help in understanding the structure of the text and identifying of key phrases.

At step 415, the system uses an extraction method to identify important entities in the text of the cookie acceptance policies amongst other terms of use or terms and conditions. Similarly, at step 420, the system will use the extraction method to identify important entities in the text of the terms and policies of the webpage, web application or a system, e.g., external cookie clauses. For example, the extraction method may be an entity extraction algorithm which extracts terms, such as “cookies,” “pixels,” “web beacons,” “IP address,” “browser,” “email client type,” “unsubscribe,” etc. as shown in FIG. 7. These extracted entities help in understanding the subject matter and context of the clause.

As should be understood by those of skill in the art, entity extraction is a process in machine learning and data analysis that involves identifying and extracting relevant features from raw data, e.g., text, without human intervention. These features are later used to create a more informative dataset, which are utilized for various tasks such as clustering as further described herein. In embodiments, the entity extraction (or also known as feature extraction) of textual data typically requires tokenization to transform it into a format suitable for the machine learning models.

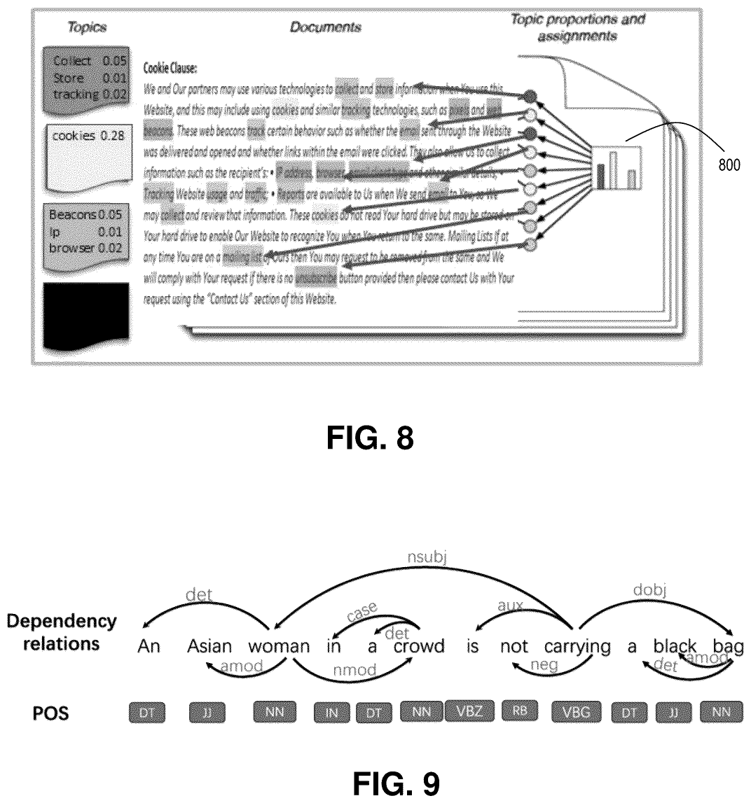

At step 425, the system uses topic modeling to identify key topics discussed in the terms and conditions document e.g., cookie acceptance policies amongst other terms of use or terms and conditions. Similarly, at step 430, the system uses topic modeling to identify key topics discussed in the text of the terms and policies of the webpage, web application or a system, e.g., external cookie clauses amongst other terms of use or terms and conditions. For example, the system identifies key topics such as, e.g., data collection, tracking activities, usage and traffic analysis, reporting, cookie storage and mailing lists, amongst other topics as shown for example, in FIG. 8.

As should be understood by those of skill in the art, topic modeling NLP enables users to identify themes/topics within a collection of documents, e.g., cookie acceptance policies and external cookie clauses (amongst other terms of use or terms and conditions). The topic modeling allows text mining to gain relevant insights from textual data. By way of example, techniques for topic modeling contemplated by the present invention include Latent Dirichlet allocation (LDA) and non-negative matrix factorization (NMF). LDA is a generative probabilistic model, and NMF is a non-probabilistic linear algebraic model which uses matrix factorization.

At step 435, the system uses dependency parsing to analyze the grammatical relationships between the words and phrases in the text of the, e.g., cookie acceptance policies. Similarly, at step 440, the system uses dependency parsing to analyze the grammatical relationships between the words and phrases in the text of the terms and policies of the webpage, web application or a system, e.g., external cookie clauses.

As should be understood by those of skill in the art, dependency parsing refers to examining the dependencies between the words of a sentence to analyze its grammatical structure as shown graphically in FIG. 9, for example. Based on this, a sentence can be broken into several components based on the concept that there is a direct link between every linguistic unit of a sentence. These links are termed dependencies. This helps the system to understand the sentence structure and the relationships between the different components of the text.

Additionally, the dependency parsing may include semantic role labeling. The role labeling identifies the semantic roles of the words and phrases in the text, such as subject, object, and predicate. For example, in NPL, the semantic role labeling is the process that assigns labels to words or phrases in a sentence that indicates their semantic role in the sentence, such as that of an agent, goal, or result. The semantic role labeling serves to find the meaning of the sentence by, for example, detecting the arguments associated with predicate or verb of a sentence and how they are classified into their specific roles. Accordingly, this process helps to understand the meaning of the sentences and how the different parts of the text are related.

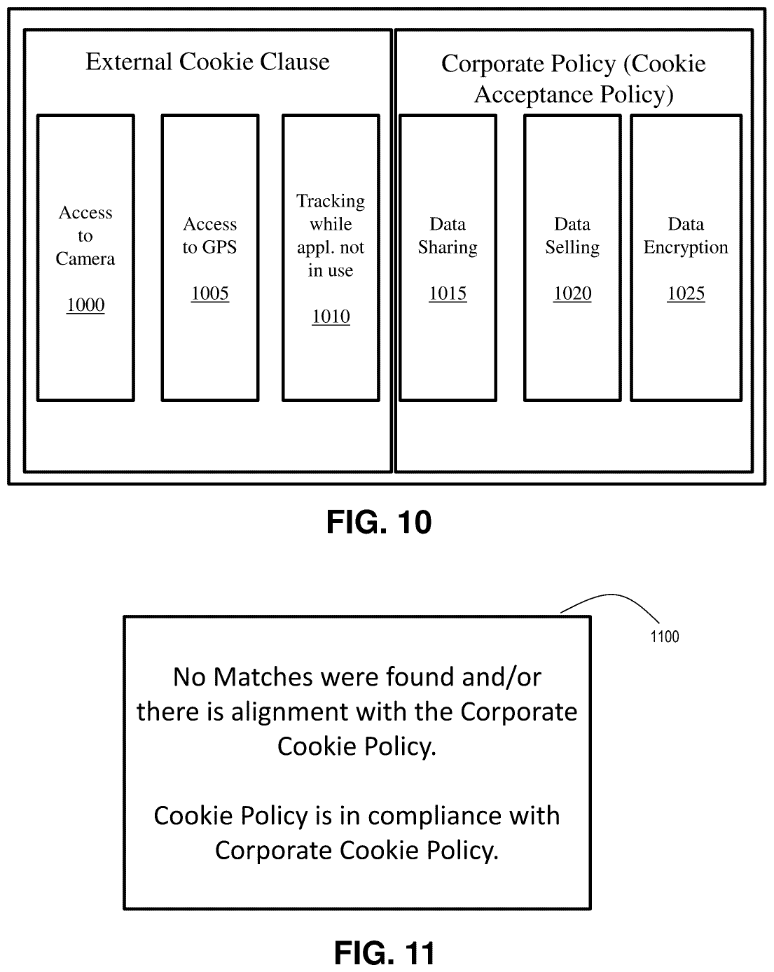

At step 445, the system creates clusters of the words and phrases in the text of the cookie acceptance policies and the text of the terms and policies of the webpage, web application or a system, e.g., external cookie clauses amongst other terms of use or terms and conditions. In embodiments, the system will use TF*IDF (term frequency-inverse document frequency) to divide the text into clusters based on similarity (as illustrated in FIG. 10). These clusters may be, for example, different identify rule such as access to camera policy, GPS policy, tracking while application is not in use, data sharing, data selling, data encryption, etc. In further embodiments, different clustering algorithms are also contemplated by the present invention including the use of K-means clustering algorithm or Balance Iterative Reducing and Clustering using Hierarchies (BIRCH) algorithm.

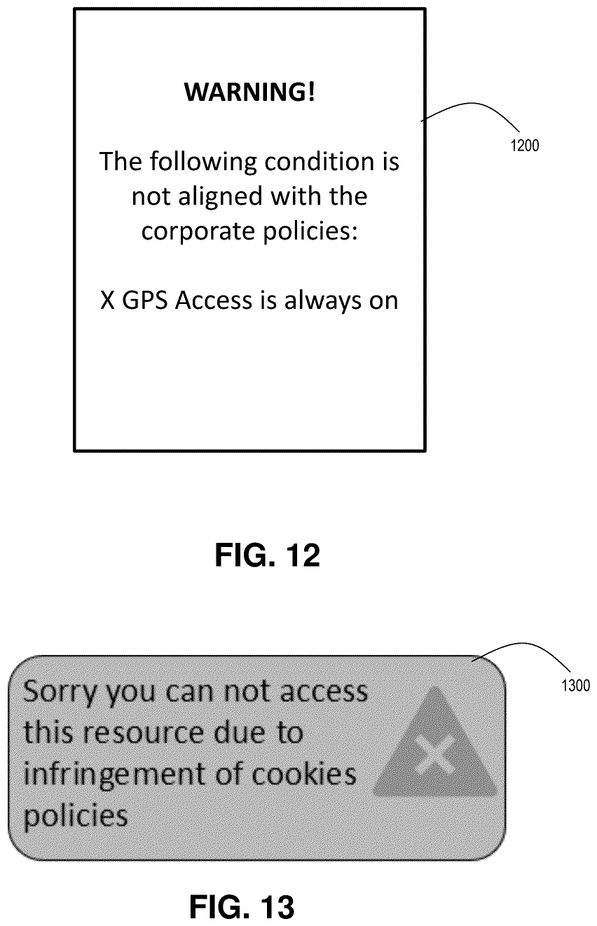

FIG. 5 shows the use of the clustering created in FIG. 4 to determine whether there may be a violation of the cookie acceptance policies by accepting the terms and policies of the webpage, web application or a system, e.g., external cookie clauses amongst other terms of use or terms and conditions. At step 500, the system will determine whether there is a match between the first set of clusters (e.g., cookie acceptance policies) with the second set of clusters (e.g., from the external cookie clauses). If a cluster match is found, at step 510, the system will correlate the clusters associated with the acceptance policies and the external clauses. This step will determine whether the acceptance policies are aligned with the external clauses. At step 505, if there is no match found between the clusters of the acceptance policies and the external clauses at step 500 or the specifications of the policies align at step 510, a message is displayed that the external clauses are aligned with the acceptance policies (e.g., terms of use or terms and conditions) (see FIG. 11). On the other hand, if the specifications do not align, at step 515, the system will run an execution engine to execute certain actions based on the violation. These actions include, for example, displaying a pop-up message, blocking access to the webpage, execute an automatic notification to the security team about potential violations or include the webpage in a block list. FIGS. 12 and 13 show actions that may be executed as further described herein.

By way example use case, the system, method and/or program product will ingest the terms and conditions of the cookie clause (amongst other terms of use or terms and conditions) of a website, web application or other system (referred to as an “external cookie clause”) and the internal policies (e.g., cookie acceptance policy). The system, method and/or program product will analyze the external cookie clause and the cookie acceptance policy by using an NLP algorithm such as, e.g., a tokenization algorithm. This is shown representatively at FIG. 6. In this case, the partial sentence 600, e.g., “use various technologies to collect and store information” will be broken into its constituent words as shown by reference numeral 605.

The system, method and/or program product will use, for example, entity extraction algorithms to identify important entities in the text, e.g., “cookies,” “pixels,” “web beacons,” “IP address,” “browser,” “email client type,” and “unsubscribe”, etc. as shown in FIG. 7. For example, the entity extraction algorithm will select (e.g., highlight) certain keywords or phrases in the external cookie clause that may be deemed relevant to the cookie acceptance policy, as shown at reference number 700.

In addition, for example, the system, method and/or program product will use topic modeling to identify key topics in the external cookie clause that may be deemed relevant to the cookie acceptance policy as shown in FIG. 8 at reference number 800. These key terms may be, for example, data collection, tracking activities, usage and traffic analysis, reporting, cookie storage and mailing lists as a few examples.

As shown graphically in FIG. 9, the system, method and/or program product will use dependency parsing to analyze grammatical relationships between the words and phrases in the text. For example, as shown in FIG. 9, “Asian” and “woman” and “crowd” are related to one another; whereas, “Asian”, “carrying” and “bag” are found not to be semantically related to one another. In this process, the system, method and/or program product will perform, for example, a semantic role labeling to identify the semantic roles of the words and phrases in the text, such as subject, object, and predicate. This helps to understand the meaning of the sentences and how the different parts of the text are related.

The system, method and/or program product will perform an NLP, trained similarly to a sentiment analysis engine, to determine the specifics of each rule. For example, assuming the following paragraph:
When installing apps, GPS access should be limited and only share location with the app when this is absolutely needed. Also, GPS access should only be provided when the app in use.”
   The system, method and/or computer program product may convert the above paragraph into: “Access to GPS=Only when app in use”

In embodiments, it should be understood that terms and conditions may be expressed in positive or negative tense; however, the system, method and/or computer program product will leverage features from NLP including sentiment analysis to determine the intent of the phrase, thus regardless of how it is written, the system, method and/or computer program product will be able to determine the intent of the sentence. The system, method and/or computer program product will also leverage feature types of NLP including large Language models (LLM) to improve its accuracy in classifying the data, determining the intent and performing the matching.

The system, method and/or program product will divide the paragraphs or other text into clusters based on similarity as shown in FIG. 10. In this example, the external terms and conditions of the website, web application or other system (external cookie clause) may be provided into the following clusters: “Access to Camera” 1000, “Access to GPS” 1005, and “Tracking while the application is not in use” 1010. The cookie acceptance policy may be provided into the following clusters: “Data Sharing” 1015, “Data Selling” 1020, and “Data Encryption” 1025. It should be recognized that even if the different policies are written in different words, the clustering will allow the system, method and/or computer program product to determine if a given policy is part of any of the groups.

The system, method and/or program product will try to match the set of clusters from the internal security policies with the set of clusters from the external cookie clause to find potential matches and identify non-compliances with the internal security policies. If no matches are found or if matches are found, but the terms of the clusters align with one another, e.g., the terms of the external cookie clause comply with the internal security policies, the system, method and/or program product may provide a notification to the user that the external cookie clause is compliant and that the user can continue to the website, web application or system, etc. An example message 1100 is shown in FIG. 11.

On the other hand, if matches are found and no compliance has been found, e.g., the external cookie clause is not in alignment with the internal security policies, the system, method and/or program product will provide an execution action based on the results. Some illustrative actions are provided in FIGS. 12 and 13.

In FIG. 12, for example, a display 1200 such as a pop-up message may be provided indicated a warning that that certain conditions are not in alignment, e.g., GFPS access is always on. As another example, FIG. 13 shows display 1300 indicating that access to the webpage, web application or system, etc. has been denied. Other actions may include blocking access to the webpage, executing an automatic notification to the security team about potential violations or including the webpage in a blacklist so that it cannot be accessed in the future (without the need to implement the above processes).

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
ingesting, by a computing device, internal security policies of an organization and external terms and conditions of a web-based activity;
identifying, by the computing device, topics of the internal security policies of the organization and the external terms and conditions of the web-based activity;
parsing, by the computing device, dependencies within the internal security policies of the organization and the external terms and conditions of the web-based activity;
creating, by the computing device, clusters of the internal security policies and clusters of the external terms and conditions of the web-based activity based on the identifying and parsing;
determining, by the computing device, non-compliance of terms of matched clusters of the internal security policies with terms of the clusters of the external terms and conditions of the web-based activity natural language processing; and
blocking, by the computing device, the web-based activity based on the non-compliance of the terms.

2. The method of claim 1, further comprising extracting, by the computing device, features of the internal security policies of the organization and the external terms and conditions of the web-based activity, and further comprises an analysis of text of the extracted features using a natural language processing (NLP) algorithm to break down the text into individual words or tokens.

3. The method of claim 2, wherein the NLP algorithm comprises tokenization which splits the text into tokens that are fed into a language model.

4. The method of claim 2, wherein the extracting comprises utilizing an entity extraction algorithm which extracts terms from the internal security policies of the organization and the external terms and conditions of the web-based activity that are of importance.

5. The method of claim 1, wherein the parsing of the dependencies comprises analyzing grammatical relationships between words and phrases in the internal security policies of the organization and the external terms and conditions of the web-based activity.

6. The method of claim 5, wherein the parsing of the dependencies comprises linking words together within a sentence that are related to one another.

7. The method of claim 5, further comprising providing semantic role labeling to identify semantic roles of words and phrases in text of the internal security policies of the organization and the external terms and conditions of the web-based activity.

8. The method of claim 7, wherein the clustering comprises creating clusters with similar rules related to the words and phrases in the text of the internal security policies of the organization and the external terms and conditions of the web-based activity.

9. The method of claim 8, further comprising determining, by the computing device, that at least one cluster from the internal security policies of the organization and at least one cluster of the external terms and conditions of the web-based activity match and in the matched clusters there is an alignment of the rules.

10. The method of claim 9, further comprising taking an action when there is no alignment of the rules within the matched clusters, which is indicative of a violation of the internal security policies of the organization.

11. The method of claim 1, wherein the computing device includes software provided as a service in a cloud environment.

12. A computer program product comprising one or more computer readable storage media having program instructions collectively stored on the one or more computer readable storage media, the program instructions executable to:
ingest internal security policies of an organization and external terms and conditions of a web-based activity;
cluster terms within the internal security policies based on similarities and which identify rules;
cluster terms within the external terms and conditions of the web-based activity based on similarities and which identify rules;
matching and comparing the clusters to determine that external terms and conditions of the web-based activity violate rules of the internal security policies; and
provide an action based on whether the clusters match and have an alignment of the rules within the matched clusters,
wherein the matching of the clusters comprises matching a set of clusters of the external terms and conditions and a set of clusters of the internal security policies and, if no match exists, the action comprises allowing access to the web-based activity, and denying access to the web-based activity when the rules are not in alignment.

13. The computer program product of claim 12, wherein the matching of the clusters comprises matching a set of clusters of the external terms and conditions and a set of clusters of the internal security policies and, if no match exists, allow access to the web-based activity.

14. (canceled)

15. (canceled)

16. The computer program product of claim 15, further comprising placing the web-based activity on a blacklist when the rules are not in alignment.

17. The computer program product of claim 15, further comprising providing a notification to a user that the rules are not in alignment.

18. The computer program product of claim 15, further comprising allowing access to the web-based activity when the rules are in alignment.

19. The computer program product of claim 15, further comprising, prior to the clustering:
identifying topics of the security policy and the external terms and conditions of the web-based activity;
parsing dependencies within the internal security policies of the organization and the external terms and conditions of the web-based activity; and
creating clusters of the internal security policy and clusters of the external terms and conditions of the web-based activity based on the identifying and parsing.

20. A system comprising:
a processor, a computer readable memory, one or more computer readable storage media, and program instructions collectively stored on the one or more computer readable storage media, the program instructions executable to:
ingest internal security policies of an organization and external terms and conditions of a web-based activity;
cluster terms within the internal security policies based on similarities and which identify rules;
cluster terms within the external terms and conditions of the web-based activity based on similarities and which identify rules;
matching and comparing the clusters to determine that external terms and conditions of the web-based activity violate rules of the internal security policies; and
provide an action based on whether the clusters match and have an alignment of the rules within the matched clusters,
wherein the action comprises allowing access to the web-based activity the clusters if no match exists between a set of clusters of the external terms and conditions and a set of clusters of the internal security policies and denying access to the web-based activity when the rules are not in alignment.

21. The method of claim 1, further comprising analyzing ingested cookie acceptance policies and the external cookie clauses of the internal security policies of the organization and external terms and conditions of the web-based activity using a natural language processing (NLP) algorithm to break down the text into individual words or tokens and preventing acceptance of the cookies associated with the external terms and conditions of the web-based activity that do not comply with the internal security policies of the organization policy and thereby ensuring compliance during enrollment on web applications.

22. The method of claim 21, further comprising finding any prohibited actions that occur by accepting a policy of the web application and prohibiting the prohibited actions.
